(19) United States
(12) Patent Application Publication
(10) Pub. No.: US 2020/0354198 A1
(43) Pub. Date: Nov. 12, 2020

(54) Lifting System, Beam and Method For Containers, Trailer for Containers, Connector For Containers

(71) Applicant: BLOK CONTAINER SYSTEMS LIMITED, Warwick (GB)

(72) Inventors: Martin CLIVE-SMITH, Warwick (GB); John EVANS, Stockport (GB)

(73) Assignee: Blok Container Systems Limited, Warwick (GB)

(21) Appl. No.: 16/078,004

(22) PCT Filed: Feb. 17, 2017
(86) PCT No.: PCT/GB2017/000021

§ 371 Date: Aug. 14, 2018

(30) Foreign Application Priority Data
Feb. 20, 2016 (GB) 1602977.9
Apr. 18, 2016 (GB) 1606718.3
May 23, 2016 (GB) 1609055.7
Nov. 16, 2016 (GB) 1619420.1
Dec. 1, 2016 (GB) 1620430.7

(51) Int. Cl. B66C 1/10; B60P 1/64; B65D 90/00

(52) U.S. Cl. CPC B66C 1/102; B60P 1/649; B65D 90/0013; B60P 1/6481

(57) ABSTRACT

A system for lifting shipping containers each having corner fittings provided with lifting/fastening apertures, the system including lifting means for lifting en masse a matrix of containers including two or more columns of vertically connected containers, each column being at least two containers high. The lifting means uses the lifting apertures provided on the top of the top container in each column, and connecting means are provided for connecting each column transversely to each adjacent column to hold the columns together and prevent toppling of the columns relative to each other. A method of lifting is also disclosed together with a lifting beam and trailer and for use in handling containers.

This invention relates to systems and methods for lifting shipping containers during loading and unloading of vessels and trailers.

One of the issues with shipping containers is that on a given vessel up to 25% of the containers may be being transported in an empty condition to the place where their cargo is to be containerised.

These empty containers are commonly transported on the decks of vessels as they weigh less and thus affect the stability of the vessel less. It is not uncommon for such empty containers and more dangerously lightly loaded containers to be stacked in side by side columns up to ten containers high (i.e. 29 m high by a column width of only 2.4 m) which can lead to major instability problems in rough seas leading to severe container damage with some containers even falling overboard due to sideways swaying movement of these columns despite the lower containers in these columns being lashed to the deck to resist swaying movement. Stability problems can also arise when columns of containers are being stacked at port facilities and during high winds. Typically the transverse gap between containers on the newer large ships is 25 mm although this does vary and gaps of up to 125 mm are in service.

In addition to the above instability problems, there is also a handling issue with such containers in that the dockside handling cranes and other equipment is designed to handle heavily loaded containers and deck hatch covers which can weigh up to 45 tons whereas individual empty containers only weigh typically 4 tons and thus if a convenient and safe system and method of lifting multiple empty or lightly loaded containers simultaneously could be devised a very significant reduction in handling times could be achieved.

It is an object of the present invention to provide such a system and method for lifting containers which addresses the above two problems.

Thus according to the present invention there is provided a system for lifting shipping containers each having corner fittings provided with lifting/fastening apertures, the system comprising lifting means for lifting en masse a matrix of containers consisting of two or more columns of vertically connected containers each column being at least two containers high, the lifting means using the lifting apertures provided on the top of the top container in each column, and connecting means for connecting each column transversely to each adjacent column to hold the columns together and prevent toppling of the columns relative to each other.

The lifting means may comprises a pair of lifting beams designed to extend across the ends of the top containers in each of the columns of containers in the matrix, the lifting beams having connectors designed to connect with lifting apertures provided on the top containers in each column of the matrix, an upper surface of the lifting beam having apertures designed to connect with connectors of a lifting spreader of an associated crane to lift the matrix via the beams.

Other features of the beams are claimed in claims 3 to 12 of the application.

The connecting means may comprises a pair of oppositely directed arms arranged to extend transversely when in use between vertically adjacent corner fittings of two container columns to be connected, at least one of the transversely extending arms having at least one connector designed to engage one of the corner fittings between which the arm extends.

The connecting means may have at least one central plate arranged to extend perpendicularly from a central region of the arms to lie between the corner fittings of adjacent columns of containers to be connected by the connecting means.

Other features of the connecting means are claimed in claims 15 to 18 of the application.

The present invention also provides a lifting beam for use in the above system, the beam having lifting apertures in an upper surface for receiving connectors to secure the beam to one or more craning spreaders and having other connectors mounted in a lower surface for connecting the beam to containers to be lifted. Such a beam can therefore itself provide the transverse connecting means between columns. Other features of the lifting beam are claimed in claims 20 to 27 of the application.

The invention also provides a connecting means for use in the above system, the connecting means comprising a pair of oppositely directed arms arranged to extend transversely when in use between vertically adjacent corner fittings of two container columns to be connected, at least one of the transversely extending arms having at least one connector designed to engage an aperture in one of the corner fittings between which the arm extends.

Other features of the connecting means are claimed in claims 29 to 35 of the application.

The present invention also provides a method of lifting shipping containers comprising forming a matrix of containers each provided with corner fittings having lifting/fastening apertures by stacking the containers in two or more columns of vertically connected containers each column being at least two containers high, connecting each column transversely to each adjacent column to hold the columns together and prevent toppling of the columns relative to each other, and lifting the matrix of columns en masse using the apertures in the corner fittings provided on the top of the top container in each column.

Other features of this method are claimed in claims 37 to 43 of the application.

The invention further provides a trailer having a frame and wheel base designed to support an assembly of containers which is at least two columns of containers wide.

Other features of this trailer are claimed in claims 45 to 52 of the application.

The present invention will now be described, by way of example only, with reference to the accompanying drawings in which:

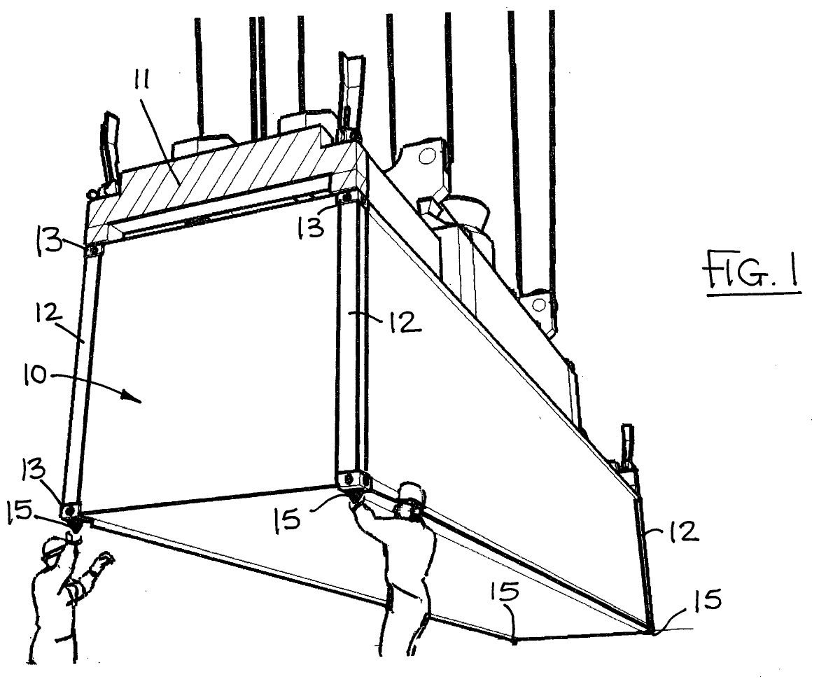

FIG. 1 shows a perspective view of a conventional shipping container suspended from a crane spreader being fitted with twistlocks into its bottom corners before being raised onto a container ship;

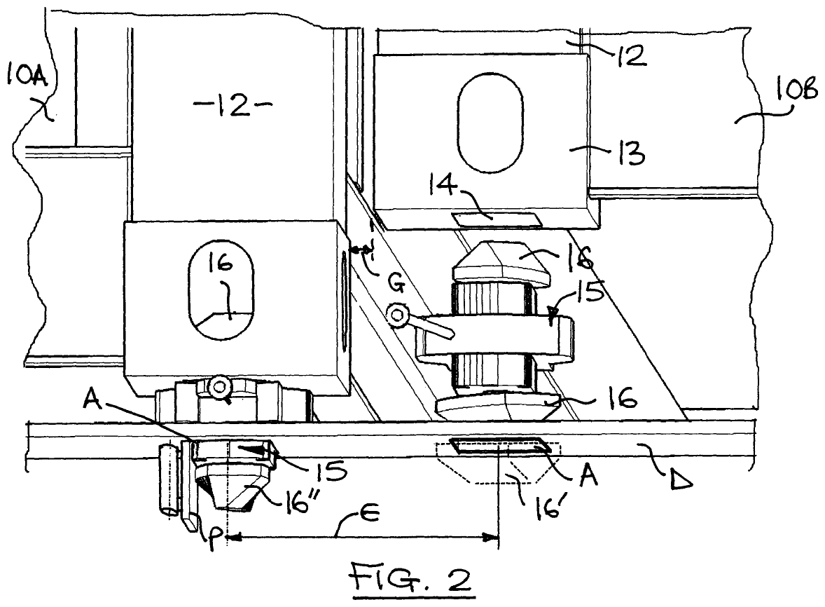

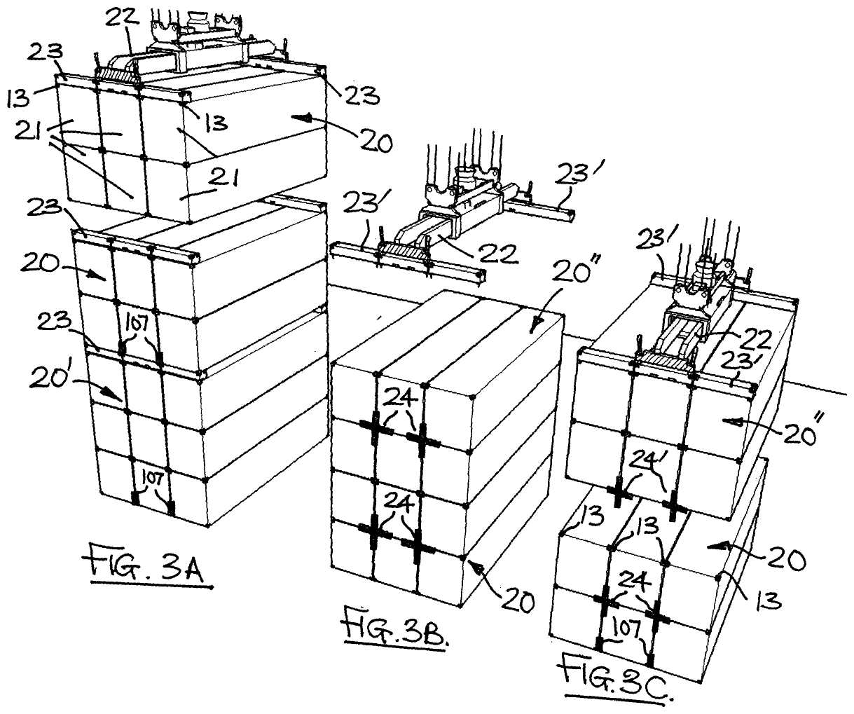

FIG. 2 shows a perspective view of the connection of corners of two adjacent shipping containers using known twistlock connectors;

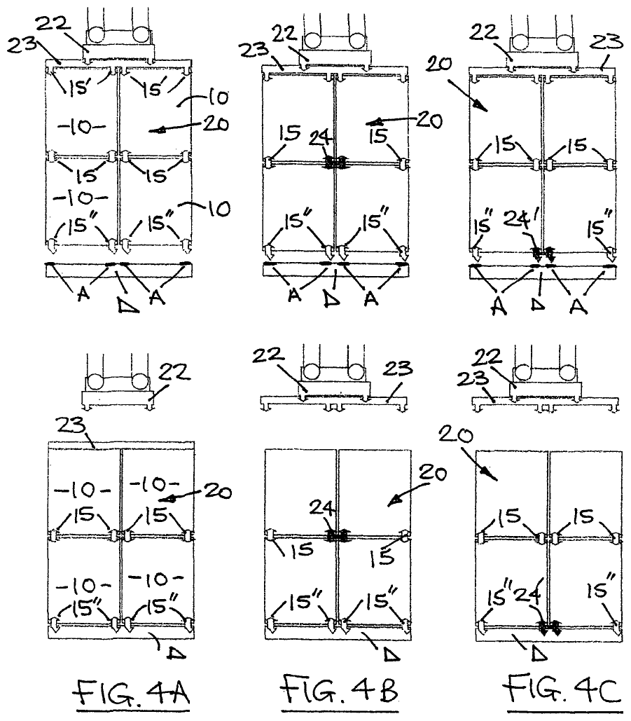

FIGS. 3A to 3C show the different manner in which matrices of containers can be stacked in accordance with the present invention;

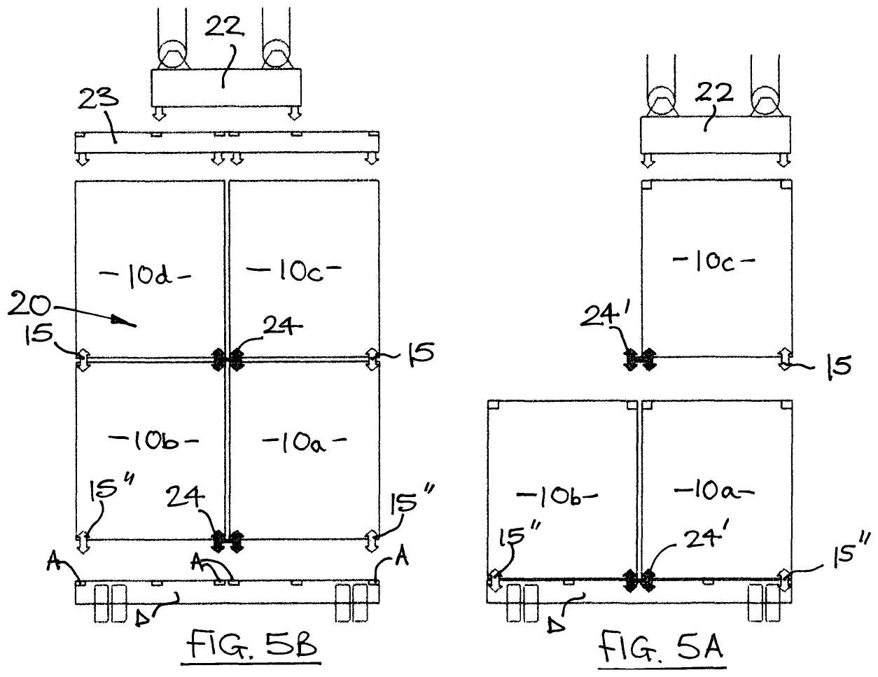

FIGS. 4A to 4C show diagrammatically different twistlock and shearlock arrangements when lifting containers in accordance with the system and method of the present invention;

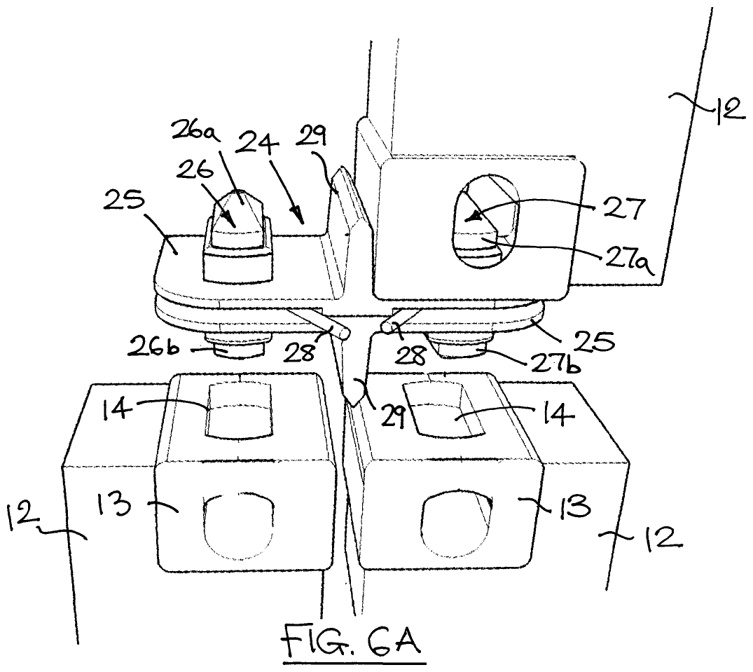

FIGS. 5A and 5B show details of one way to construct a matrix of containers for use in the present invention;

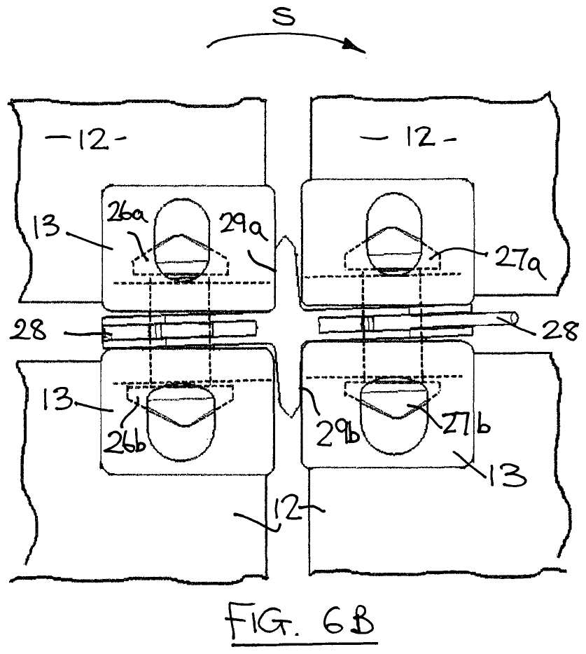

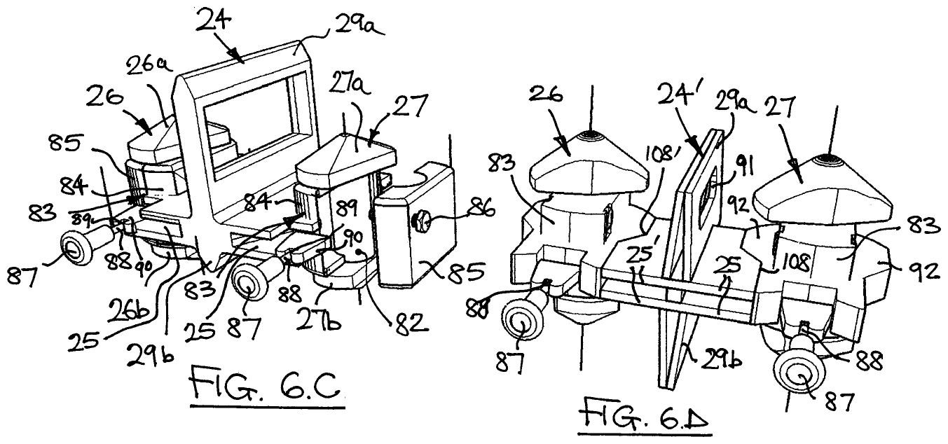

FIG. 6A and 6B show details of a form of shearlock used in the system of the present invention;

FIG. 7A illustrates diagrammatically how two high unconnected columns of containers can move relative to each other when swaying leading to failure of a lower container and subsequent toppling of a column;

FIG. 7B shows how connecting together these two columns can help prevent failure and subsequent toppling;

FIG. 7C shows how matrices loaded by the system and method of the present invention can be stacked in a horizontally staggered configuration for improved stability;

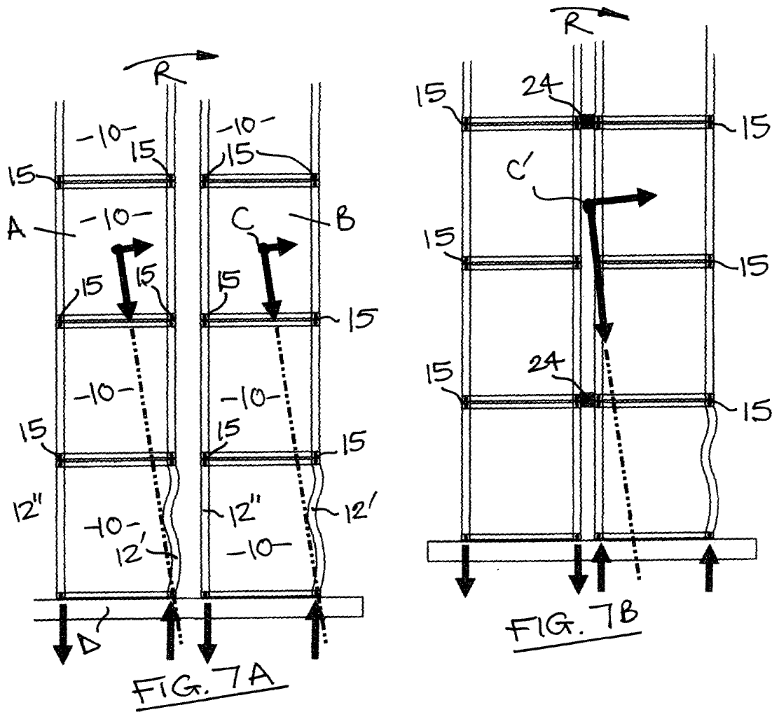

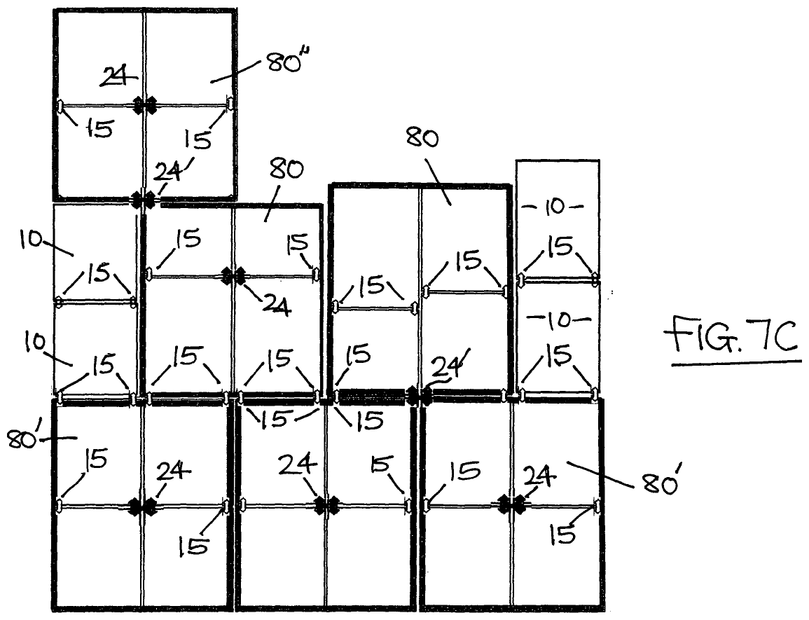

FIG. 8 shows a perspective view of part of a lifting beam used in the system of the present invention;

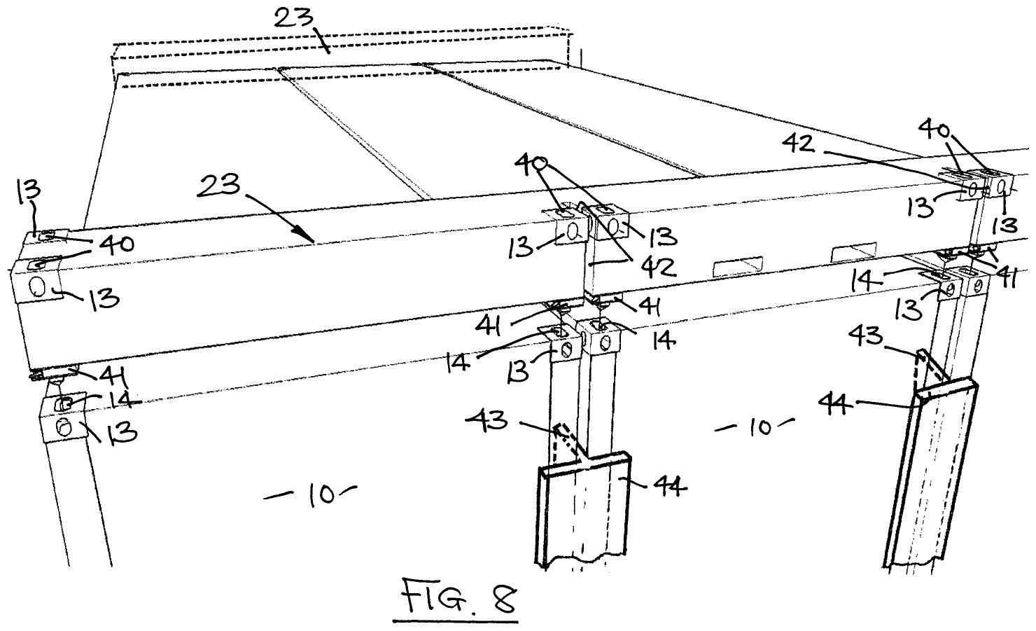

FIG. 9 diagrammatically illustrate a variable length lifting beam which has pivoting end sections to extend its length;

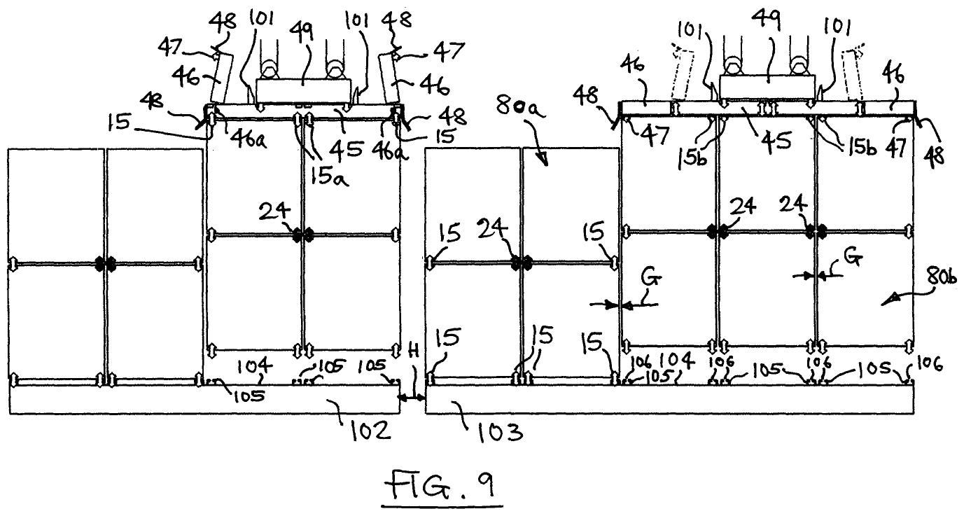

FIG. 10 shows a lifting beam in accordance with the present invention being lifted by a first craning spreader while a second connected spreader directly lifts a separate column of containers;

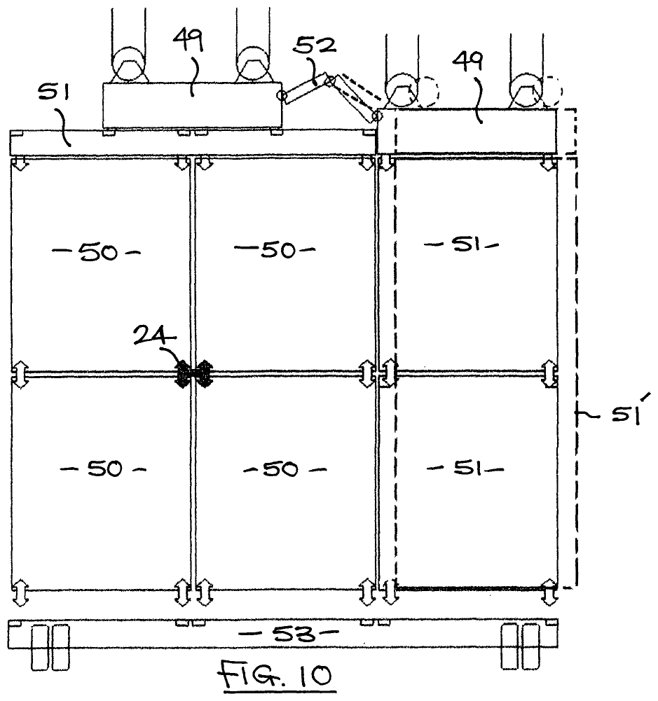

FIGS. 11 to 14 show the sequence of coupling a lifting beam in accordance with the present invention with columns of containers to be lifted;

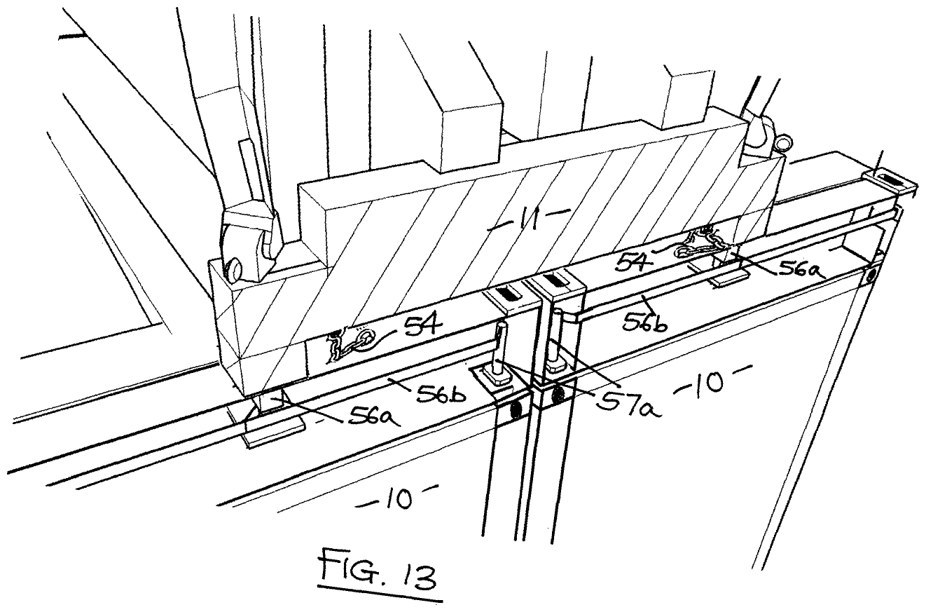

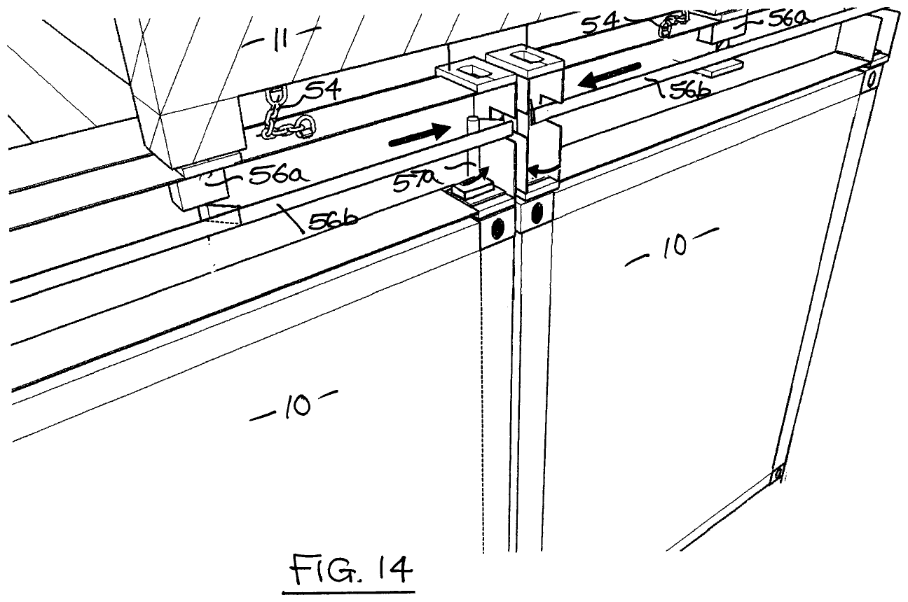

FIG. 14A shows an alternative form of lifting beam in accordance with the present invention which uses wire ropes to operate its connectors;

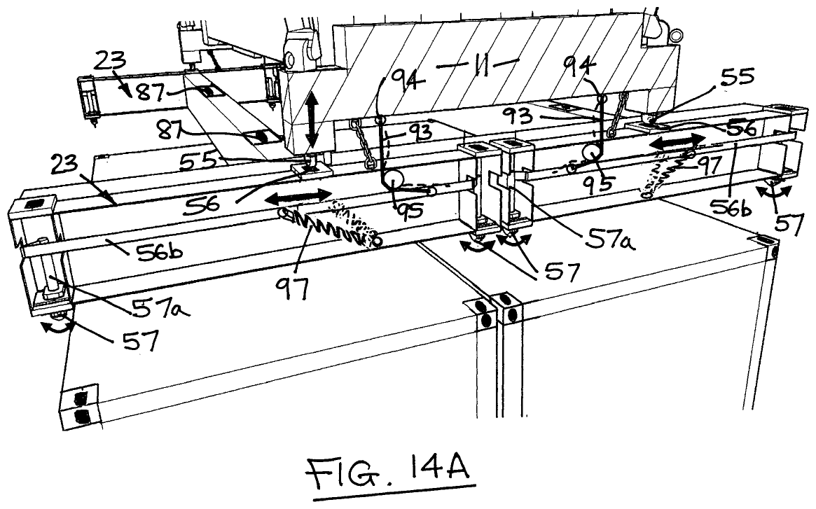

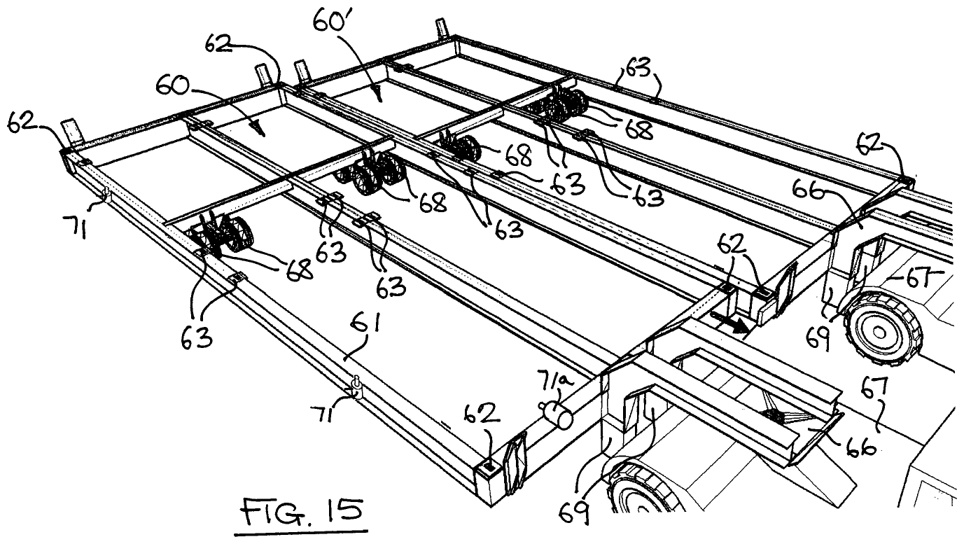

FIGS. 15 and 16 show perspective views of a trailer in accordance with the present invention, FIG. 16 showing the trailer being loaded;

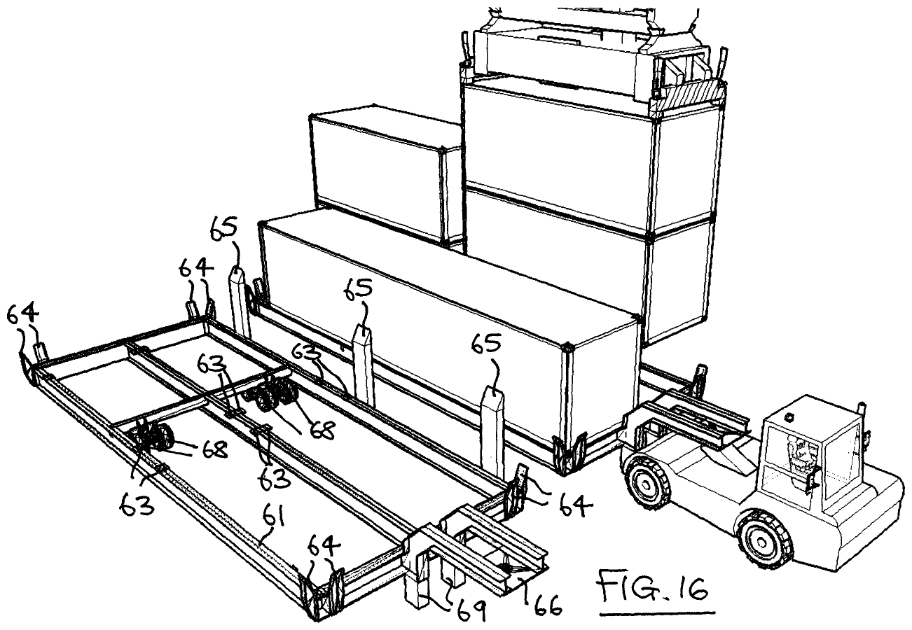

FIG. 17 shows an underside view of an alternative arrangement of trailer able to accept a 3 column matrix on a 2 column wide trailer;

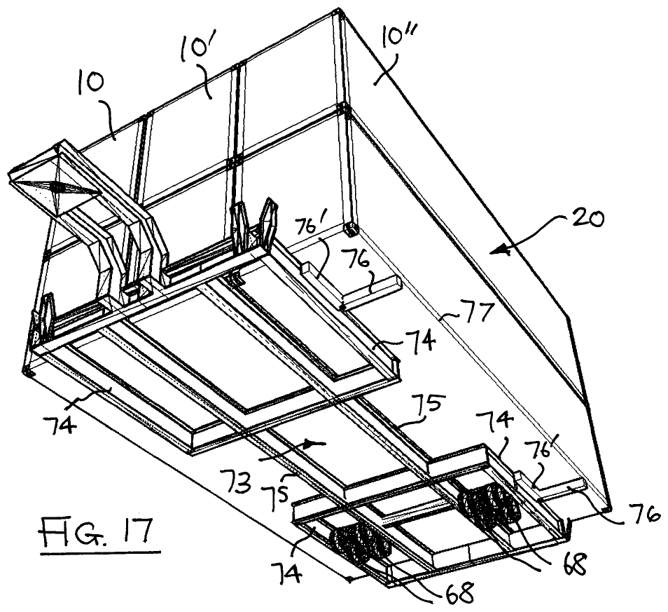

FIG. 18 shows examples of a number of different matrix configurations which can be used in accordance with the present invention;

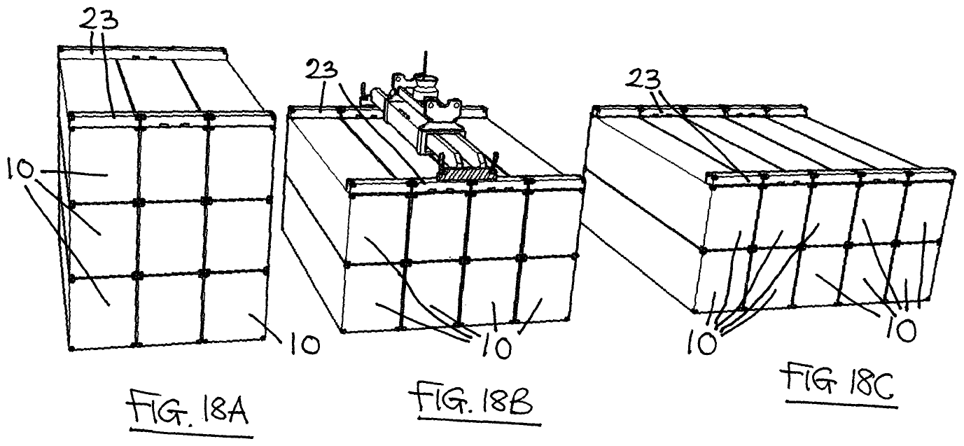

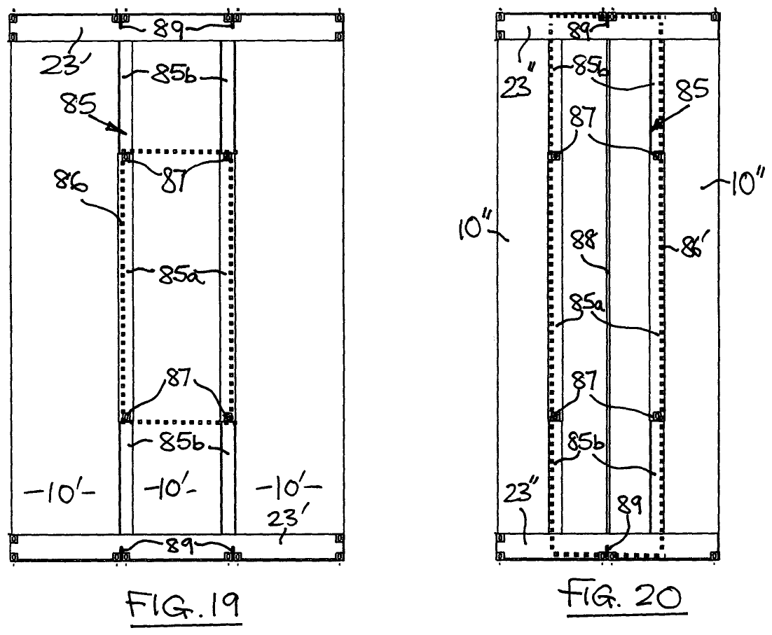

FIGS. 19 and 20 shows how two lifting beams in accordance with the present invention can be lifted via support beams which are telescopic longitudinally of the containers to be lifted, and

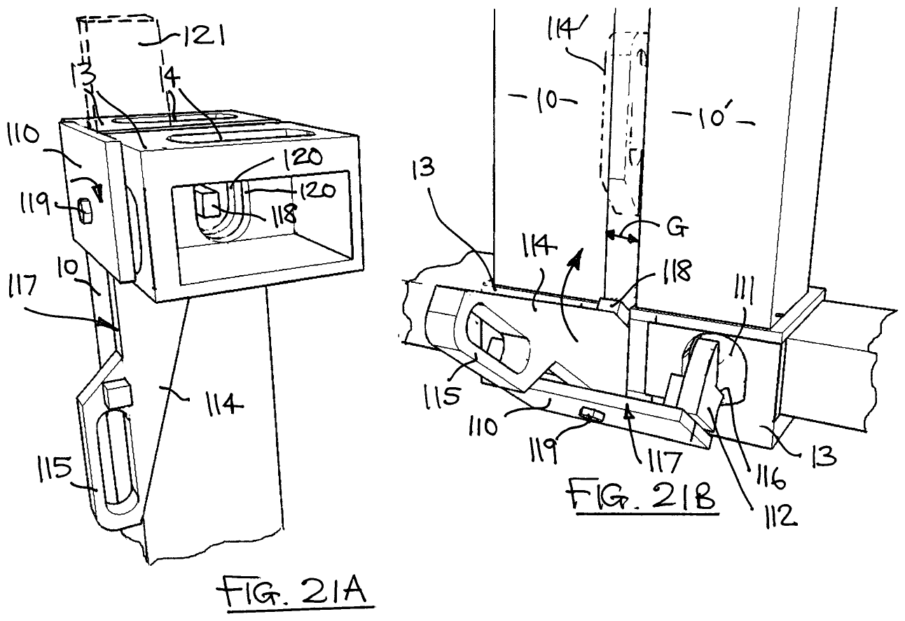

FIGS. 21A and 21B show perspective views of an alternative form of shearlock in accordance with the present invention.

Referring to the drawings, FIG. 1 shows a typical shipping container 10 about to be raised onto a container ship by a conventional crane spreader 11. The container has four corner posts 12 each with a corner fitting 13 at its top and bottom. These corner fittings each have apertures 14 on their exposed faces. The horizontal apertures 14 in the corner fittings (not visible in FIG. 1) have so-called twistlocks 15 inserted into them to connect adjacent containers one above the other or to a deck or to trailer as shown in FIG. 2.

Numerous types of twistlocks are available some being manually operated, others semi-automatic or fully automatic and some with no moving parts. These twistlocks all have oppositely projecting heads 16 (see FIG. 2) which are insertable into the top and bottom apertures 14 of the corner fittings 13 to be connected and which are normally then rotated manually or by inbuilt spring loading to prevent withdrawal of the head from the aperture. Since the operating mechanisms of such twistlocks do not form part of the present invention and such twistlocks are well known they will not be described in any further detail. Examples of such twistlocks and their operation are described, for example, in U.S. Pat. No. 3,752,511 which describes a manually operated twistlock and in U.S. Pat. No. 5,791,808 which describes a semi-automatic twistlock both of which can be used to lift one empty container from another empty container from above. An example of a fully automatic twistlock is described in U.S. Pat. No. 7,942,601 and an example of a socalled Smartlock is described in U.S. Pat. No. 7,621,414. These two types of twistlock are used for locking containers down to a deck or another container but not for lifting. Other twistlocks with one head only are built into known spreaders for top lifting containers through the top apertures in their corner fittings as in patent U.S. Pat. No. 3,749,438.

In FIG. 2 there is seen adjacent lower corners of two containers 10A and 10B placed on a deck D of a trailer there being apertures A formed in the structure of the trailer so that the spring loaded semi-automatic twistlock 15 illustrated on the right with its two heads 16 rotated an angle about its vertical axis could clip into the bottom aperture 14 of the container 10A above and the aperture A of the trailer deck D below locking the container when lowered to the trailer as the heads rotate inside the elongate apertures 14, A as illustrated by dotted line 16′ for the bottom head. One the left hand side the container 10A is seen already seated on the trailer deck D but in this example a plate P has been arranged adjacent to the trailer aperture A so that as the spring loaded head 16″ tries to rotate back under its spring loading once through the aperture, it encounters the plate P and cannot rotate below deck D to lock to the trailer. The plate it is envisaged to be moveable so that a choice can be made whether to allow the container to be locked to the trailer or simply act as a shear spigot stopping the container from sliding horizontally from the trailer.

Such twistlocks are also used when containers are stacked one on top of each other, for example on a deck of a vessel to lock the containers together vertically and thus stabilise the columns of containers and help to reduce swaying movement of the columns as referred to above.

The spacing E (see FIG. 2) between the apertures A is predefined (by for example, the design of the deck hatches on a ship which form the deck). So it follows that any containers loaded and stacked onto the deck and connected by twistlocks 15 will be spaced apart by an amount determined by the spacing of the deck apertures A. Typically this spacing results in a horizontal gap G of 25 mm between the fittings 13 of adjacent containers 10. However variations of gap G do occur by design and so different models of the present invention are envisaged to accommodate gap requirements.

FIG. 3A shows the basics of the present invention in which a matrix 20 of six empty containers 21 in three columns. In forming the matrix a horizontal gap G typically of 25 mm is provided between the containers in the matrix by jigging the containers on a jig trailer D described later in FIG. 5. FIG. 3A shows the matrix 20 being lifted by a conventional crane spreader 22 using a lifting means in accordance with the present invention in the form of a pair of lifting beams 23 which engage the apertures in the corner fittings 13 on the top of the top container of each column. These lifting beams 23 also connect each column of containers transversely to its adjacent columns thus holding the columns together and preventing toppling of the columns relative to each other.

Thus this basic system not only provides a solution to the problem of lifting a matrix of empty containers simultaneously by directly lifting each column but also helps to stabilise the matrix against swaying and toppling by transversely connecting the columns. The system of the present invention can also utilise the existing infrastructure of quays, cranes, spreaders, containers and handling machines. Note that the matrix 20 shown is of 6 containers but can also be of other quantities such as the nine container matrix 20′ shown below matrix 20 in FIG. 3A.

This lifting beam system can be operated in two manners. In one manner of execution the beams 23 can be left in place during transportation as shown in FIG. 3A, with the beams 23 being strengthen to take the stacking loads which will be incurred. This arrangement does increase the vertical stacking height of the containers but the presence of the beams reduces the effect of side winds on the containers when they are stacked on a quay or the deck of a vessel as the wind can pass through the gaps in the container matrix formed by the beams.

Alternatively, and possibly more economically seen in FIG. 3B, the beams 23′ can remain attached to the lifting spreader 22 and a given matrix 20″can simply be loaded on top of and fastened to a previously loaded matrix 20 using known twistlocks 15 in the lower apertures of corner fitting 13 of the upper matrix 20″which are secured into the apertures 14 on the top of the lower matrix 20. When the containers are transported with the lifting beams removed, the columns of the matrix are still connected together transversely at each end of the matrix to stabilise the columns against topping etc by a connecting means in the form of at least two shearlocks 24 for a 3 column matrix and at least one shearlock for a 2 column matrix. The shearlocks hold the connected columns against vertical and transverse movement relative to each other. An example of a suitable shearlock 24 is shown in FIG. 6A and 6B. In FIG. 3C an alternative location of the shearlocks 24′ is seen projecting below the upper matrix 20″ being lowered by a spreader 22 and beams 23′ such that the shear locks 24′ connect with the top fittings 13 of the matrix lower 20 below or indeed a deck, trailer or individual containers all with suitable apertures to receive them.

It will be appreciated that the shearlocks 24 and 24′ could be used when the beams 23 are left in place during transportation for added stability.

Beams 23, 23′ have inherently some flexibility and free play in the twistlock mechanisms. So as they are lifted by spreaders 22, the containers 10 hanging from them tend to deflect inwards towards each other such that the gap G measured at the bottom corner fittings of the bottom containers tends to close up. Indeed if the beams 23 are particularly light weight and flexible the gap can close entirely. That closure has the advantage of reducing the bending moment felt by the beam 23 during lifting due to a horizontal reaction generated at spacer 107. To reset Gap G of preferably 25 mm a spacer 107 (shown diagrammatically in FIGS. 3A and 3C) of about 100 sq. cm of Styrofoam, plastic, wood or other lightweight material able to withstand a compressive load of some 10 tonnes is placed between the corner fittings or other structural part of the adjacent containers to maintain the gap G. These spacers are so light that should they fall out, no injury to personnel would occur.

In FIG. 4A, 4B, 4C there is seen end elevations of matrixes 20 of four containers 10 with illustrated diagrammatically twistlocks and shearlocks 24, 24′ in various positions. The upper part of FIG. 4A shows a spreader 22 lifting a beam 23 connected to the tops of two upper containers by twistlocks 15′ connected to each corner of each upper container. Suspended from the top row of containers are two more similar containers with their top corners connected by twistlocks 15 to the bottom corners of the upper row of containers. These twistlocks 15 must be suitable for lifting such loads and are envisaged to be semi-automatic twistlocks for preference. Note that each column is individually suspended from the beam 23 and that in spite of there being the provision of shearlocks 24 in FIG. 4B the vertical lifting loads of the columns pass directly into the beam 23, yet the beam 23 spans all columns at each end of the matrix. Under the bottom row of containers, there is seen yet more twistlocks 15″ and since these twistlocks need not be used on the bottom of a matrix for lifting but only locating the matrix, these twistlocks can therefore be, for example, Smartlocks 15″ which can be released from the structure below by simply rotating the container slightly about a vertical axis and without requiring manual release of each lock.

When the matrix is lowered onto a structure D such as a vessel deck or trailer including twistlock apertures A located to receive the Smartlocks 15″of the lower containers (illustrated in FIG. 2) or onto a row of similar containers or matrix (illustrated in FIGS. 6A and 6B), the twistlocks 15″ engage with the top apertures in these devices and because of their automated function, they lock into the structure under the force of gravity as shown in the lower view of FIG. 4A in which the spreader 22 has been raised leaving beam 23 connected to the matrix 20 to stabilise the matrix during transportation.

In FIG. 4B, the beam 23 is seen in the lower view to have been lifted off the matrix 20. To prevent toppling the matrix has been fitted with shearlocks 24 at the centremost junction of the container ends at each end of the matrix. Stabilised like this, the matrix can be more safely transported on a trailer or shipped away to sea. Although it has been calculated that just one shearlock is needed per end of a matrix of four containers, more can be added or they can be repositioned as illustrated in FIG. 3C and 4C where they are located at the bottom of the bottom row of containers at 24′. Here once connected to a structure D the shearing and toppling restraint of the shearlocks is complete.

FIGS. 5A and 5B show how a matrix 20 similar to that shown in FIGS. 4A to 4C can be constructed. In FIG. 5A container 10a is loaded onto a trailer D by a spreader 22 having been fitted with a twistlock 15″ and a shearlock 24′ on its lower corners on a twistlock feeding table. In this example a feeding table would feed semi-automatic twistlocks into the apertures set as known ready to lock automatically into an aperture below once the container was lowered onto a deck, trailer or container having suitable apertures. The twist lock 15″ and shearlock 24′ enter apertures provided on the trailer without connecting with the trailer as described above in relation to FIG. 2 and plate P, for example. The location and spacing of the apertures A is critical and determines the gap G between the columns in the matrix. A second container 10b is then loaded beside container 10a with further twistlocks 15″ fitted to the lower outer corners of container 10b. The other lower inner corners of container 10b engage with the shearlocks 24′ loaded with container 10a. A further container 10c is then loaded in the same manner as container 10a on top of container 10a with its lower corners having twistlocks 15 and shearlocks 24′ which snap into and engage the apertures in the upper corner fittings of container 10a. Similarly a final container 10d is loaded on top of container 10b with twistlocks 15 fitted to its outer lower corners. The lower inner corners of container 10d engage the shearlocks 24′ fitted to container 10c and the twist locks 15 fitted to the lower outer corners of container 10d snap into apertures in the upper outer corners of container 10b. Lift beams 23 are then connected to the upper apertures of containers 10c and 10d to allow the matrix 20 to be lifted onto a vessel.

This procedure constructs a matrix with two shearlocks 24′at each end of the matrix which is a particularly secure configuration.

If the matrix is to be used with a beam 23 which is to remain attached to the matrix then the shearlocks 24, 24′ can be replaced by twistlocks 15 and 15″which simply connect the containers vertically and the beam 23 can provide all the necessary transverse connection between the columns of the matrix.

If all or some of these twistlocks were of the manual operational twistlock types, then they would be locked by a stevedore from the ground with a known operating pole or by hand from a ladder or walkway not shown.

When dismantling the matrix described manual twistlocks would be undone as described. Where semi-automatic twistlocks have been used these are released by a stevedore on the ground armed with a pole using known techniques and twistlock features.

In FIG. 6A and 6B one embodiment of the shearlock 24 has a pair of oppositely directed arms 25 each supporting a twistlock 26,27. Each twistlock has its respective head 26a, 27a and tail 26b, 27b for engagement with the apertures in the corner fittings 13 of four adjacent containers. In the example shown the twistlocks are manually operated by handles 28 which rotate the heads and tails 26a, 27a and 26b, 27b to lock the containers together as is well known. The shearlock 24 also has a pair of perpendicular central plates 29 which are designed to extend vertically between adjacent columns of containers to maintain the desired spacing between the columns and to help resist any tendency for the containers to sway relative to each other during transportation as can be seen in FIG. 6B in which plates 29 contact the adjacent columns at 29a and 29b when the columns sway as indicated by the arrow S.

In an alternative form of the shearlock shown in FIGS. 6A and 6B the central plates 29 can be shortened or omitted. This tends to provide less stable columns as the plates 29 can no longer make contact at 29a and 29b.

Where used at the bottom of the bottom row of containers as illustrated in FIG. 4C where a bottom shearlock 15″ is to be positioned onto a vessel deck or trailer D there is no place for the lower plate 29b to go so plate 29b would be omitted. It is envisaged that the bottom shearlock 15″ in such a position needs no lifting capacity and thus it is envisaged that at least the twistlock heads 26b and 27b be formed as Smartlocks. Such an arrangement is illustrated in FIG. 4C so that a matrix 20 can be lowered or lifted without need to release manual or semi-automatic twistlocks had they been used in this location.

In FIG. 6C and 6D other embodiments are shown where known semi-automatic twistlocks of proven construction and operation are adapted to make the shearlocks. Known twistlocks 26, 27 are of the semi-automatic construction having heads 26a, 26b, 27a, 27b the pairs of heads being joined together by shaft 82 which rotates with the heads inside a collar 83 comprising two half shells 84, 85. The outermost shell 85 has been unbolted to show the shaft 82 inside. The shells are held together by bolts 86. The shaft and heads are rotated against the internal springs not shown which drive them towards their locked position. A toggle 87 is provided which is anchored to a wire rope 88 which wraps around the shaft and by pulling firmly on the toggle, the shaft is rotated within the collar thereby rotating the heads against the internal springs to unlock the heads. In a known manner, to maintain the heads unlocked the wire rope 88 of the toggle can be pulled and urged into one or more slots 89 in a clevis plate 90. For example, two positions can be provided corresponding to different amounts of pulling on the rope 88, In one position the head 26a is held unlocked and head 26b remains locked and in the other position the head 26a remains locked and head 26b is unlocked. On releasing the toggle rope 88 from the slots the internal springs return both heads to their locked position.

FIG. 6D shows a shearlock 24′ of fabricated construction with handling aperture 91 formed in plates 29a. Plates 29a, 29b, and arms 25, 25′ comprise profiles of steel plate welded together to form the shape required of the shearlock 24′. The arms 25 are welded to the stacking flanges 92 of the twistlocks 26, 27 to make the shearlock structure described earlier. The connection between connectors 26, 27 and the arms 25, 25′ is made along joint lines 108, 108′ between the existing flanges 92 of the twistlocks 26, 27 and the arms 25, 25′ which are profiled to meet them. This enables a shearlock to be made from known twistlocks of proven strength which are ready for use. It is envisaged however that the shear lock assembly could be made with twistlock 26 not joined to the left hand arm 25′ along line 108′ but simply profiled to encompass at least partly and be retained by the connector 26. In this arrangement connector 26 would be a standard free moving device, and the shearlock 24′ would have a shortened arm 25′ to be clear of connector 26. In operation, container corner fittings stacked above and below the arm 25′ would trap it with the compressive loads generated between the containers and the shearlock 24′ would still provide shearing and deflection restraint between two adjacent columns and be connected to one of the containers in one column via connector 27. In a further variant of this construction neither of the connectors 26, 27 are joined to the arms 25′, 25 and the shearlock 24 is simply held in place by being gripped between the corner fittings between which it extends.

In FIG. 6C a similar construction is formed this time from arms 25 and plates 29a, 29b which are a forging or a steel casting which is combined with the innermost shells 84 of the collars 83. The shells 85 complete the assembly by being bolted to the shells 84 with known bolts 86. In this way a substantial part of the assembly is made from standard known parts whilst providing an integrated strong centremost structure of few parts.

FIGS. 7A and 7B diagrammatically illustrate the consequences associated with the swaying or toppling of high columns of containers. In FIG. 7A are shown two columns A and B of containers 10 which are held together by conventional twistlocks 15 at their corners. If the deck “D” of the vessel tilts up to 25 degrees or more due to rolling “R” in high seas adjacent faces of columns A and B deflect vertically relative to each other due to elastic and indeed plastic yielding of the columns and the centre of gravity “C” of the columns passes outside the base of the columns leading to toppling of, for example, the column B. As rolling increases the load on the outermost corner post 12′ can begin to fail in buckling which is a catastrophic failure. Once buckling of post 12′ occurs the remaining inner post 12″cannot support the containers above and the containers fall overboard into the sea taking other single columns with them in a domino effect.

In FIG. 7B two columns A and B of containers 10 are shown with the containers in each column being connected by twistlocks 15 and the two columns being connected transversely by shearlocks 24 in accordance with the present invention. Beams 23 which are not used here would have a similar effect as shearlocks 24. The shearlocks 24 provide a shear constraint between the columns thus preventing the vertical movement between adjacent columns which greatly stabilises the columns of containers. As can be seen from FIG. 7B a much greater angle of rolling is reached before the centre of gravity C′ of the transversely connected columns falls outside the base of the columns. Also if buckling of corner post 12′ begins to occur the remaining connected posts 12″ are capable of relaxing the buckling loads and help prevent a catastrophic failure.

In the arrangement of FIG. 7B there are several corner posts 12″ to resist the failure of post 12′. These additional corner posts 12″provide multiple load paths for resisting any tensile loads through the twistlocks in these posts 12″ again giving a safer arrangement.

Further enhancement of the stabilising effect of the sheerlocks and matrixes is illustrated in FIG. 7C which shows how the stability of matrices 80 of connected containers can be improved by stacking the matrices in a transversely staggered manner or bridge stacking on board the transportation vessel on the dockside. The matrixes may be of varying heights as can single columns of containers. Each matrix, which may be two, three or more columns wide, is connected together by the twistlocks 15 and shearlocks 24 described above. It also illustrates that the top of the matrixes need to be level for bridge stacking yet can be formed from containers of different heights and in vertically staggered configuration still be provided with shearlocks 24 or bottom shear locks 24′. Beside the matrixes 80 is seen a single column of containers 10 locked to the matrix 80′ and each other via twistlocks 15. Under rolling seas such a short column is safe from toppling. If the columns are level and thought to be unstable or the space is needed, a further matrix 80″ can be stacked on top of the single column for added stability and more so if shearlock 24′ is provided at the bottom connection of the matrix 80″ as shown at the top left hand corner of the containers shown in FIG. 7C.

So it can be seen that a mix of matrixes and single columns can be accommodated by the system. The single columns might also be located inboard of the matrixes so that they do not experience the full accelerations caused by rolling which are greatest at the outermost reaches of the vessel from its metacentre. Similarly single columns can be placed below the matrixes the shearlocks or beams still providing a restraining effect on those single columns.

Part of a lifting beam 23 for lifting three columns of containers is shown in more detail in FIG. 8. The upper surface of beam 23 has twistlock apertures 40 similar to the apertures provided in the corner fittings 13 of the containers. These apertures 40 are vertically aligned with the apertures 14 of the corner fittings 13 of the containers in the columns of containers 10 to be lifted by the beam. The lower surface of beam 23 may include integral twistlocks 41 or loose twistlocks located in apertures formed in lower surface of the beam 23. These twistlocks can be operated manually, automatically, electro-hydraulically and/or remotely.

The beam may also be provided with slots 42 to accommodate the blades 43 of any container cell guides 44 fitted in the vessel's cargo hold. These guides 44 are commonly fitted to stabilise the columns of containers during transit. A similar beam 23 can be seen fitted to the other end of the containers to be simultaneously lifted.

The lifting beams 23 although essentially rigid along their full span and allowing for natural free play in the mechanisms can also be made telescopic so that, for example, a beam can be extended to lift either two or three columns of containers. This extending beam function is particularly practical if the beam is designed to be disconnected after the matrix of containers has been loaded in the hold. Beams of adjustable length can also be useful in accommodating different spacings between containers or different aperture spacings on a vessel or trailer.

FIG. 9A and 9B show two other beam arrangements for accommodating different numbers of columns of containers without the need for the spreader 49 to change from a fixed length two container wide beam as in FIG. 4 to a three container wide beam as in FIG. 3 thus saving operational time and accommodation space for additional beams.

In FIG. 9A the beam has a central section 45 and folding end sections 46 which include twistlocks 47 and guide plates 48 which when in use tend to draw the tops of the container columns together and thus speed up alignment of the beam twistlocks with the container corner fitting apertures. The end sections 46 are attached by pivot pins 46a to the beam 45 and operated by hydraulic rams (not shown) used to raise and lower the section 46. When lowered the ends of the end sections 46 abut the ends of the central section 45 of beam to support the load imposed on the end sections 46 when lifting containers. When retracted, guide plates can be fitted to the ends of central section 45 to suit a now two container wide configuration. Because the end sections 46 abut the ends of the central section 45 when lifting no locking of the end sections 46 relative to the central section 45 is required when in the deployed lowered position to be able to lift the load of containers below.

FIG. 9A shows the beam 45 with its end sections 46 folded up so that the beam can lift two columns of containers via a centrally mounted spreader 49. In this arrangement centrally located shearlocks 24 are used to provide the transverse connection between the two columns of containers when the beam 45 is removed with the spreader 49 and twistlocks 15 are used at the other contacting corners of the matrix. In FIG. 9B the end sections 46 of the beam 45 are folded down so that three columns of containers can be lifted via the spreader 49. Additional twistlocks in different locations are needed to lift three containers instead of two so twistlocks 15a and 15b are made retractable so that they can be raised and lowered and there locked for operation. Centrally located shearlocks 24 are again used to transversely connect the three columns of containers with other twistlocks in the middle of the rows hold the two rows together, and if required, more twistlocks deployed along the bottom of the matrix.

To ease the location of spreader 49 onto beam 45 chamfered guide plates 101 are fixed to the top of the beam so that when the spreader is being lowered onto the beam, it is guided closely to the position where its connectors can easily slot into the beam lift apertures.

In FIG. 9 there is illustrated known container ship deck hatches 102, 103. These hatches form the deck surface 104 onto which containers are stacked. Beneath them are the holds of the ship not shown. Welded to the surface 104 are known deck fittings 105 comprising a steel box able to support the massive weight of containers stacked above and having in their upper surface an aperture 106 of the same geometry as described before ready to receive and be locked to known twistlocks including smartlocks, semi-automatics and fully automatics. The spacing of the apertures must suit the containers to be stacked upon them and commonly the resulting gap between adjacent containers in single columns is 25 mm although other configurations are known. Thus the matrix 80a or 80b needs to be configured to have a matching gap G to sit comfortably and engage with the deck fittings. Between the hatches 102, 103 is a gap H which is necessitated by the massive supports needed under them bridging the open hold of the ship. The overall width of the ships vary and hatches are made in many different widths of two containers wide to seven, and possibly more. So for a Matrix to efficiently and fully occupy the widths of the hatches the hatches need to have a width equal to the width of a whole number of matrixes. Thus, for example, matrix 80a is two containers wide and matrix 80b is three containers to match the width of hatch 103. Similarly the width of hatch 102 is equal to two 80a matrices.

FIG. 10 shows how tandem spreaders 49 can be used to lift a matrix of four containers 50 via a lifting beam 51 alongside a single vertical column of containers. The two spreaders 49 are connected by a linkage 52 which can be hydraulically or electrically operated and which can adjust the transverse spacing between the containers 50 and the column 51 up to say 200 mm (see dotted detail 51′ so that gaps caused on the deck of vessels by hatch covers can be negotiated and the columns the drawn closer together for loading on a trailer 53, for example or spaced apart if needed.

FIGS. 11 to 14 show the connection of a lifting beam 23 to a matrix of containers in a vessel's hold for lifting of the matrix out of the hold. This beam includes no motive power to operate its connectors and is thus much cheaper to construct.

In FIG. 11, 12, 13, 14 the beam 23 is shown suspended below a lifting spreader 11 via chains 54. The spreader has integral twistlocks 55 which are remotely operated, for example electrically or hydraulically. The beam has apertures 56 in its upper surface to receive the twistlocks 55 and integral twistlocks 57 in its lower surface for engagement with apertures 58 in the upper corner fittings of the matrix. Below each aperture 56 is a box 56a into which the twistlocks 55 are to be inserted. These boxes 56a are connected by linkages 56b with rods 57a which operates twistlocks 57. Thus when the twistlocks 55 are rotated, by the motive power provided on the spreader 11, to lock into apertures 56, the boxes 56a are also rotated to move linkages 56b and this rotate twistlocks 57. Twistlocks 55 are suspended by chains 54 close to apertures 56 or even slightly entering the apertures to help engagement.

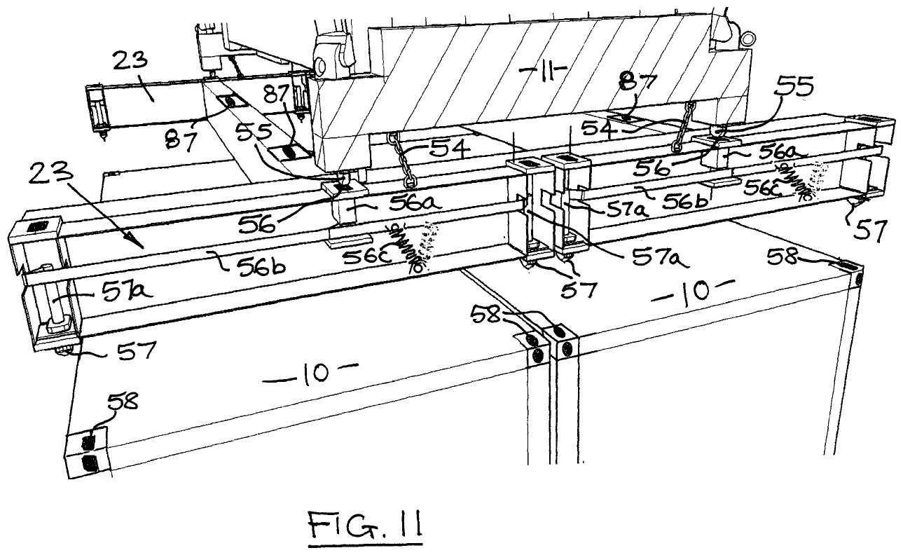

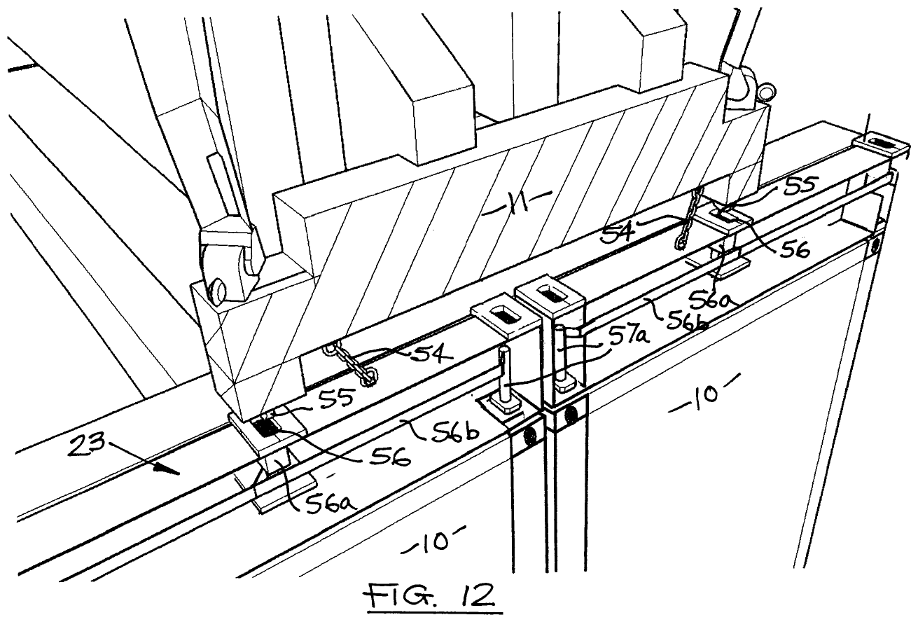

With all the twistlocks in their open positions the beam 23 is lowered so that the twistlocks 57 enter the apertures 58 as shown in FIG. 12. The spreader 11 is then lowered so that chains 54 go slack and the weight of the spreader bears on the beam 23 urging it into firm engagement with the corner fitting of the containers as shown in FIG. 13. A safety system then signals to the crane operator that it is safe to rotate the twistlocks 55 to lock the spreader 11 to the beam 23. The twistlocks 57 are thus also operated by rotation of boxes 56a, as described above, so that the matrix is now safely locked to the spreader 11 and may be lifted from within the vessel's hold as shown in FIG. 14. It will be appreciated that there is substantial lost movement through the mechanism from spreader twistlocks through beam apertures through boxes mounted on bearings to linkages to beam twistlocks to container fitting apertures. The beam twistlocks 57 need to rotate about 80 degrees between locked and unlocked and the lost movement accounts for some 20 degrees. Therefore it is envisaged that the twistlock linkage 56 and/or the individual twistlocks 57 will be fitted with over-centre springs such as compression spring 56c captured between beam and linkage, as shown in FIG. 11, that ensure full rotation of the twistlocks from a fully open position to a fully locked position is achieved.

It will be appreciated that the beam can be provided with its own motive power (e.g. electrical and/or hydraulic) for the operation of the twist locks 57 in which case the beam may remain attached to the spreader 11 at all times and the safety system will detect the correct entry of the twistlocks 57 into apertures 58.

A lifting beam with an alternative twistlock operation is seen in FIG. 14A in which two wire ropes 93 are anchored to the spreader 11 at rings 94. The ropes pass down from the spreader to beam 23 and pass around pulleys 95 pinned to the beam where they are attached to linkages 56b which operate the twistlocks 57. The twistlocks are connected to springs 97 mounted on the beam 23 which rotate each twistlock towards a locked position. In the position shown in FIG. 14A the spreader 11 and beam 23 are raised above the containers 10 and the ropes 93 are tensioned pulling the twistlocks to their open position. As the beam is lowered to the point where the twistlocks 57 enter the apertures 58 of the containers 10, the spreader comes to rest on the beam 23 and the tension in the ropes 93 relaxes thus allowing the springs 97 to pull the twistlocks around into the locked position within the corner fittings 13 of the containers. The spreader twistlocks 55 can now rotate inside the apertures 56 of the beam and safely lift the beam and containers. To release the beam from the containers once on the ground, the reverse procedure takes place with spreader release, raise up, tension the ropes, rotate the beam twistlocks and lift the beam up and away from the containers.

The invention also provides a trailer 60 for loading a matrix of containers on to for movement around a port facility. The trailer, see FIGS. 15 and 16, comprises a basic rectangular frame 61 which in the version shown is designed to carry a matrix of containers two columns wide. The frame 61 includes apertures 62 to receive any twistlocks or shearlocks fitted to the bottom of the lower container in each column. The frame may also include additional apertures 63 to enable 20 foot long containers to be loaded in a tandem configuration instead of 40 foot containers. The trailer may also include guides 64 adjacent its corners to help position the matrix on the trailer during lowering. Additional posts 65 may be provided along one or more the sides of the trailer to stabilise the bottom container in each column. This is a particularly useful feature if the columns of containers are not transversely connected when they are on the trailer.

The trailer has a towing attachment 66, which may be of the fifth wheel type, for towing by a port tractor unit 67. The wheels 68 of the trailer are located wide apart for improved stability and near the longitudinal centre of the trailer so that the turning circle is reduced as is tyre scrubbing when turning. Retractable props 69 are provided which may be hydraulically or electrically operated and which keep the trailer level during loading of the containers. The trailer is naturally flexible so that in the event that the containers cannot be loaded level and gaps between the corner fittings is out of gauge for the fitting of sheet locks or the connection to spreaders easily. Adjustment means comprising in this example jacks 71 with removable handles 72 are mounted on the frame 61 and can be extended upwards to meet the bottom side of a container to raise one side of it thus tilting it and closing an excess gap that might occur between it and an adjacent container. Jack 71a can also move a container longitudinally relative to the trailer frame 61 if necessary. In addition to facilitating loading of containers onto the trailer the jacks can also assist the manoeuvring of containers to engage connectors such as shearlocks or twistlocks carried by containers already loaded on the trailer.

As indicated above, the trailer may be used to transport a matrix of containers in which the containers are transversely connected by beams 23 or shearlocks 24 in which case the matrix may not require locking to the trailer using twistlocks located in the bottom apertures of the lower containers in each column of the matrix. On the other hand, if the trailer is loaded with columns of containers which are not transversely connected the columns may be made more secure by locking the bottom container in each column to the trailer using twistlocks.

The preferred trailer embodiment is as described as a semi trailer with rear most wheels and a 5^{th} wheel connection to a terminal tractor. However it is envisaged that the trailer might be made as a trolley with steer wheels at least at the front able to be linked entrain with other similar trolleys. It is further envisaged that other vehicles might be formed for road or rail, self propelled or towed, having the ability to receive and support in stable manner matrixes of containers at least 2 columns wide having wheel spacing to ensure a stability able to not tip over sideways which is greater than that of a single column of containers placed on a typical trailer of 2.5 m width.

FIG. 15 shows two trailers 60 and 60′ drawn up side by side with trailer 60 about to contact an end plate 70 on trailer 60′ to ensure the alignment of the two trailers. This trailer configuration enables a matrix of containers four columns wide to be loaded simultaneously onto the two trailers suspended below two lifting beams and when the beams are disengaged the two trailers can be driven away separately thus speeding up container handling and resulting in a two column wide load which is handlable on conventional docksides.

If the trailer is to be used in situation where it is not necessary to lock the containers to the trailer the locking apertures 62,63 can be omitted. It will be appreciated that the above trailer arrangement allows a trailer to be easily and quickly stacked with containers either in matrix form, or in vertically connected columns or individually without the need for expensive special equipment.

Containers need to have twistlocks inserted into their bottom corner fittings before loading them on board the deck of an ocean going vessel and this is a dangerous job if done manually as the operators must stand beneath the raised containers. The trailer described above can be used as a twistlock fastening bed by dropping semi-automatic or automatic twistlocks into the apertures 62 where they are held without being fastened to the trailer and then lowering containers onto these twistlocks so that the twistlocks can then click into the corner fittings of the lowered containers without any manual intervention and are then lifted with the containers when the containers are raised from the trailer to be loaded to engage known deck sockets.

FIG. 17 shows an alternative arrangement of a trailer 73 similar to trailer 60 here viewed from underneath. On it is placed a matrix 20 of 3 columns wide which overhangs the side frames 74. The overall width of the wheels 68 still within the 2 column wide trailer 60 of FIGS. 15 and 16 but is such that they provide enough stability even to a 3 column wide matrix. To side load the centre containers such as 10′, the side frame 74 is formed with a recess to rail 75 wide enough for a large fork lift truck to enter and reach to the centre location occupied by container 10′. The matrix being locked together by shear locks ensures that the cantilevered containers 10″ do not fall off the trailer. However to provide additional support, outriggers 76 are provided which slide out of the frame 73 or as in this example are hingedly attached to the frame 73 moveable from a location 76′ to a position 76 there able to support the bottom side rail 77 of the container 10″.

FIGS. 18A to 18C show diagrammatically examples of a number of different matrix configurations which can be used in accordance with the present invention. In FIG. 18A the matrix has nine containers 10 in three columns lifted via two beams 23. In FIG. 18B eight containers in four columns are lifted by two beams 23 and in FIG. 18C ten containers in five columns are lifted by two beams 23.

As will be appreciated, when a matrix of containers is lifted by a pair of beams there is a tendency for the ends of the beams to deflect downwards so that the bottoms of the containers tend to deflect inwards towards each other thereby closing the required gaps between them. To prevent this, spacers formed from plastics foam blocks, magnetic blocks or light metal pressings can be used. These spacers can be adhered to or clipped onto the sides or other parts of containers. Foam blocks are particularly suitable as high density polyethylene of a size of 200×200 mm is able to support a force of 2 tonnes or more and if it is knocked off will not cause injury to personnel working on the loading. If these spacers encounter cell guides they can safely be knocked off and left for scrap since they are only intended for a one time use to maintain a gap between containers so that the cell guides can slide between the containers.

FIGS. 19 and 20 show diagrammatic plan views of liftng beams 23′ and 23″ connected with three columns of containers 10′ and two columns of containers 10″respectively. In FIG. 19 the two beams 23′ are joined by longitudinally extending support beams 85 which are telescopic so that different lengths of containers can be lifted. The support beams each have a central section 85a and end sections 85b which can be slid inside the central section 85a using hydraulic rams or other actuators. This arrangement also allows, for example, a twenty foot lifting spreader shown by dotted detail 86 to engage apertures 87 in the central section 85a of beams 85 to lift forty foot long containers. In FIG. 20 beams 23″ are again connected by longitudinally telescopic beams 85 which in this example are shown being lifted by a forty foot spreader shown by dotted detail 86′ which is located centrally over the gap 88 between the containers to provide a balanced lift. The beams 23′ and 23″ can also be provided with slots 89 to accept any cell guides used in the vessel's hold.

As can be seen in FIG. 20 the forty foot spreader 86′ would overlap the slots 89 and thus prevent this arrangement being used when cell guides are present. This issue can be overcome by using a twenty foot spreader engaged in the apertures, 87 at the ends of the central sections 85a of the support beams 85 as shown in FIG. 19.

Although the invention has been described above in relation to empty containers it is envisaged that it can also be used with lightly loaded containers. For example, a cargo of cars or white goods evenly distributed so that the gross weight of the lightly loaded matrix is no heavier than say four columns of two rows of empty containers could be lifted using the system of the present invention.

In another embodiment the shearlock 117 can be manufactured in a different configuration. There is seen in FIG. 21B a close up detail of the bottom corner fittings 13 of two adjacent containers 10 and the shearlock 110 being inserted into the end apertures 111 of the fittings. The shearlock comprises two spigots 112 (only one in view nearest to the viewer) welded to a plate 110 and a plate spacer 114 with handle 115 formed in it. The spacer is of a thickness selected preferred being 25 mm passing between the two containers to ensure the gap G is maintained. The spigots have a nib 116 on the leading tip to hook into the end aperture 111 of the corner fittings 13 so that once hooked inside the corner fitting, rotation of the shearlock 117 with handle 115 about the nib 116 forces the spacer 114 between the containers 10. In FIG. 21A the shearlock 117 is seen here mounted and locked into the top corner fittings of two adjacent containers 10. The same procedure has been used to get it to this locked position. To finalise the locking into the fittings 13, a swivel latch 118 is provided driven by a bolt 119 (the bolt head on view) which passes through plate 110 and spacer 114 and is accessible on the outside of the plate 110. Rotation of the bolt rotates the latch 118 between the corner fittings 13 and into the side apertures 120 of at least one of the fittings 13. Once engaged, the latch prevents the shearlock from rotating out of its location between the containers by virtue of its engagement with the side apertures. The spacer is also jammed between the containers and the spigots held in the end apertures of the fittings. In the event that one container 10′ has vertical shearing motions relative to the other container 10, the spigots try to move vertically with their respective containers tending to rotate plate 110 but the rotation is then restrained by the spacer 114 held between the facing faces of the adjacent containers thus preventing the shearing of one container past another.

The horizontal handling apertures 14 are still available for top lifting and bottom connection with twistlocks so it will be appreciated that this shearlock 117 can be fitted to matrixes with any known twistlocks and can be fitted at the top of a matrix without interfering with spreader twistlocks. Furthermore at the top, it can be seen by crane drivers wishing to identify which containers are formed into a matrix and which are not. The top of spacer 114 can be extended to project above the corner fittings as shown by dotted detail 121 in FIG. 21A to even more clearly indicate when this type of shearlock is in use and provide guidance for beams 23 provided with slots for cell guides.

1. A system for lifting shipping containers each having corner fittings provided with lifting/fastening apertures, the system comprising lifting means for lifting en masse a matrix of containers consisting of two or more columns of vertically connected containers each column being at least two containers high, the lifting means comprising a pair of lifting beams, each beam being designed to extend across the ends of the top containers in each of the columns of containers in the matrix to connect the columns transversely, each lifting beam having connectors designed to connect with lifting apertures provided on the top containers in each column of the matrix, and each lifting beam being connected with a lifting spreader of an associated crane to lift the matrix via the beams and the apertures provided on the top container of each column of the matrix.

2. The system according to claim 1, wherein an upper surface of each lifting beam has apertures designed to connect with connectors of the lifting spreader.

3. The system according to claim 1, wherein the lifting beams have slots to accommodate any cell guides used in a vessel in which the matrix is to be transported.

4. The system according to claim 1, wherein the lifting beams are telescopic to accommodate container matrices with different numbers of columns or different spacings between the matrix columns.

5. The system according to claim 1, wherein the lifting beams at the ends of the columns of containers of the matrix are connected to the lifting spreader via a pair of support beams which extend longitudinally of the containers in the matrix, the ends of the support beams being connected with the lifting beams at the ends of the container matrix and the spreader lifting the matrix via the support beams.

6. The system according to claim 5, wherein the support beams each have lifting apertures on top surfaces of central sections to enable a shorter lifting spreader to lift the support beams thus keeping the spreader clear of the ends of the support beams.

7. The system according to claim 1, wherein the connectors which connect the lifting beams to the containers are operated when at least one of the connectors connecting the lifting beams or support beams to the spreader are operated.

8. The system according to claim 7, wherein rotation of at least one of the connectors on the spreader within the apertures on the top the lifting beams actuates at least one of the connectors on the beams which connect the beams to the containers.

9. The system according to claim 1, wherein the lifting beams are connected to the spreader by inclined flexible links aligning the spreader connectors in close proximity to the beam apertures and guiding the spreader connectors towards engagement with the top apertures of the beam when the beams and spreader are brought together.

10. The system according to claim 9, wherein a linkage connects the spreader with the connectors on the lifting beams so that raising or lowering of the spreader relative to the lifting beams tensions or relaxes the linkage and thus operates the connectors on the beams.

11. The system according to claim 1, wherein the lifting beams are designed to remain connected with the containers via the connectors of the beams after lifting of the matrix and also to provide the transverse connecting means between the containers.

12. The system according to claim 1, wherein the lifting beams are designed to be disconnected from the containers after lifting of the matrix and separate transverse connecting means are provided between the columns of the containers.

13. The system according to claim 12, wherein the connecting means comprises a pair of oppositely directed arms arranged to extend transversely when in use between vertically adjacent corner fittings of two container columns to be connected, at least one of the transversely extending arms having at least one connector designed to engage one of the corner fittings between which the arm extends.

14. The system according to claim 13, wherein at least one central plate is arranged to extend perpendicularly from a central region of the arms to lie between the corner fittings of adjacent columns of containers to be connected by the connecting means.

15. The system according to claim 14, wherein the or each central plate sets the spacing between the corners fittings of the adjacent columns.

16. The system according to claim 13, wherein the connecting means is used on at least one group of four adjacent corners of containers vertically and horizontally adjacent each other in adjacent columns of the matrix.

17. The system according to claim 12, wherein the connecting means is used on at least one pair of two adjacent corners of containers horizontally adjacent each other in adjacent columns of the matrix.

18. The system according to claim 12, wherein the connecting means has spigots designed to enter outwardly facing apertures provided in the corner fittings of two containers to be connected, the spigots being mounted on a support plate with a central spacing member secured thereto so that, after insertion of the spigots into the apertures, the spacing member can be rotated into a position between the side faces of the corner fittings of the containers to be connected, locking means being provided to hold the spacing member between the side faces thus retaining the spigots in the apertures and connecting the containers.

19.-23. (canceled)

24. The system according to claim 1, wherein each lifting beam has a central section and end sections pivotally mounted on the central section and provided with additional connectors for connection to containers to be lifted, the folding end sections being pivotable between a raised position in which a first number of columns of containers can be lifted by the beam and a lowered position in which the length of the beam is extended to enable the lifting of a second and larger number of columns of containers.

25. The system according to claim 24, wherein the ends of the pivoting end sections abut the ends of the central section when the end sections are in their lowered position to support the load imposed on the end sections when lifting containers and act as one assembly.

26. The system according to claim 1, wherein each lifting beam has end guide plates projecting downwardly at its ends so that when lowered onto a matrix the end guide plates draw together any excess clearances between the top containers in the matrix.

27. The system according to claim 1, wherein each lifting beam has guide plates on its upper surface which guide one or more spreaders towards engagement of its connectors in the beam lift apertures.

28.-30. (canceled)

31. The system according to claim 13, wherein each arm carries connectors of the twistlock type projecting perpendicularly therefrom to engage apertures in the corner fittings between which the arms are to extend.

32. The system according to claim 13, wherein each arm carries connectors of the twistlock type projecting perpendicularly from an upper surface of each arm and connectors of the Smart type projecting perpendicularly from a lower surface of each arm.

33. The system according to to claim 13, wherein only one arm has connectors projecting perpendicularly therefrom to engage apertures in the corner fittings between which it is to extend, and the other arm simply extends between and is gripped by the corner fittings between which it extends.

34. The system according to to claim 13, wherein any connectors provided on the arms are standard connectors permanently or removably carried on the arms.

35. (canceled)

36. A method of lifting shipping containers comprising forming a matrix of containers each provided with corner fittings having lifting/fastening apertures by stacking the containers in two or more columns of vertically connected containers each column being at least two containers high, connecting each column to a pair of lifting beams fastened across the ends of the top container in each of the columns of containers in the matrix to connect the columns transversely, and lifting the matrix of columns en masse using the apertures in the corner fittings provided on the top of the top container in each column.

37. (canceled)

38. The method according to claim 36, wherein after a given matrix has been lowered into its rest position the lifting beams are disconnected and removed by the craning spreader or spreaders prior to the lowering of a subsequent matrix of containers on top of said given matrix or other containers or deck or jig.

39. The method according to claim 36, wherein after a given matrix has been lowered into its rest position the craning spreader or spreaders are disconnected from the lifting beams leaving the beams in position on the top of the matrix and a subsequent matrix of containers is lowered on the top of the lifting beams.

40. The method according to claim 36, wherein the matrix of containers is formed by loading containers on top of each other to form columns and vertically connecting the containers in each column using connectors engaging the apertures in adjacent corner fittings and transversely connecting adjacent columns using at least one connecting means at each end of each column.

41. The method according to claim 40, wherein matrix is formed on a jig which receives connectors in the same locations as those of deck, hold or trailer onto which the matrix is to be loaded.

42. The method according to claim 36, wherein the matrices are stacked in a horizontally staggered configuration on other matrices or other stacks of containers for greater stability.

43. The method according to claim 36, wherein a first craning spreader lifts a matrix of containers via the lifting beams and a second craning spreader operating in tandem with the first spreader lifts a further column of containers, the two spreaders being connected by a linkage which enables the horizontal spacing between the matrix of containers lifted by the first spreader and the column of containers lifted by the second spreader to be varied.

44.-45. (canceled)

46. The system according to claim 55, wherein the trailer is provided with guide means for guiding the columns of containers to their desired positions on the base.

47. The system according to claim 55, wherein the trailer has support posts along at least one side for stabilizing the bottom level of containers during transit on the container.

48. The system according to claim 55, wherein the trailer has the wheels located in a longitudinally mid portion of the base to reduce the turning circle of the trailer and tire scrubbing.

49. The system according to claim 55, wherein the trailer has retractable props which support the trailer in a level condition during loading/unloading.

50. The system according to claim 55, wherein the trailer has additional outriggers to support the carriage of containers stacked three columns wide on a trailer base two containers wide.

51. The system according to claim 50, wherein the trailer base has recesses in its sides to assist the loading of containers by a fork lift truck.

52. The system according to claim 55, wherein the trailer base is provided with jacks which can be used to tilt containers being loaded onto the trailer to facilitate their loading and or the engagement of any connectors carried by containers already loaded on the trailer.

53.-54. (canceled)

55. The system according to claim 1 further comprising a trailer or other transporting vehicle onto which columns of containers which have been lifted by the pair of lifting beams can be lowered, the trailer having a base designed to extend below and support the columns of containers and having apertures or connectors to cooperate with connectors or apertures provided on the bottom container of each column to stabilize and position the columns of containers on the trailer or other transporting vehicle.

56. The method according to claim 36, wherein columns of containers which have been lifted by the pair of lifting beams are lowered onto a trailer or other transporting vehicle having a base designed to extend below and support the columns of containers and having apertures or connectors to cooperate with connectors or apertures provided on the bottom container of each column to stabilize and position the columns of containers on the trailer or other transporting vehicle.

57. A method of lifting and moving shipping containers comprising lifting two columns of vertically connected containers on to a trailer or other transporting vehicle having a base designed to extend below and support both columns of containers and having apertures or connectors to cooperate with connectors or apertures provided on the bottom container of each column to stabilize and position the columns of containers on the trailer or other vehicle, the method comprising lifting the columns either simultaneously or separately onto the trailer or other vehicle using apertures provided on the top of the top container in each column and then moving the trailer or vehicle to an other location with the containers in situ, the method further comprising lifting the columns of containers off the trailer or other vehicle at this other location either simultaneously or separately again using the apertures provided on the top of the top container in each column.

58. The method according to claim 57, wherein prior to lifting the columns of containers on to the trailer or other transporting vehicle connectors are positioned in the apertures of the trailer or other transporting vehicle which are subsequently picked up by the apertures provided on the bottom container of each column and can be used to locate each column when it is subsequently lowered on to another apertured container or support member.

59. A trailer or other transportation vehicle for shipping containers, the trailer or other transportation vehicle having a base designed to extend below and support at least two columns of containers in a side by side configuration.
